(19) United States
(12) Patent Application Publication
(10) Pub. No.: US 2026/0048398 A1
(43) Pub. Date: Feb. 19, 2026

(54) CENTRIFUGE BOTTLE FOR COUNTERFLOW OPERATION

(71) Applicant: Thermo Electron LED GmbH, Osterode (DE)

(72) Inventor: Daniel Langer, Osterode (DE)

(21) Appl. No.: 19/299,900

(22) Filed: Aug. 14, 2025

(30) Foreign Application Priority Data
Aug. 15, 2024 (DE) 102024123335.4

(51) Int. Cl. B04B 5/04

(52) U.S. Cl. CPC B04B 5/0407

(57) ABSTRACT

A centrifuge bottle for counterflow operation, comprising a bottle tip being arranged radially out-wards in relation to an axis of centrifugal rotation, a bottle end opposite the bottle tip being arranged radially inwards in relation to the axis of centrifugal rotation and comprising a sample out-let, a tube for connecting the bottle tip with a sample inlet and a cavity with an outer circumference that changes over the cross-section of the centrifuge bottle from bottle tip to bottle end. The radius of the sample outlet can be higher than the radius of the sample inlet.

The invention refers to a centrifuge bottle for counterflow operation according to the preamble of claim 1.

Centrifuge bottles are used for counterflow operations in centrifuges. Counterflow operation of centrifuges is intended to concentrate and separate a specific fraction of a sample inside the centrifuge bottle or bottles of a rotor of a centrifuge. The separation is conducted by suspension of cells or particles in a fluidised bed by exerting a constant flow force against centrifugal forces. Different cells or particles have different sedimentation characteristics due to various sizes and densities, which is used for their separation with counterflow operation.

The centrifuge bottles are typically of conical shape with an essentially cylindric section towards the centre of the rotor, as for example shown in WO 2022/046572 A1, where a centrifuge bottle with a conical tip section and a cylindric section following is disclosed.

Therefore, an equilibrium between settling velocity and flow velocity of the sample inside these centrifuge bottles can only be achieved at one specific radius of the centrifuge bottle. This typically leads to a concentration of sample particles at this specific radius, accompanied by a loss of particles or pelleting of particles, each of which is undesirable as it can lead to a falsification of the analysis of a definite cell or particle content of the sample.

The problem to be solved underlying this invention is to improve the sample flow inside the centrifuge bottle so that the separation of particles via counterflow operation may be improved.

This problem is solved by the subject matter of the independent patent claim.

Advantageous embodiments and further developments are the subject of the dependent claims, the accompanying description, and the figures.

According to the invention, the problem is solved by a centrifuge bottle for counterflow operation, comprising a bottle tip being arranged radially outwards in relation to an axis of centrifugal rotation, a bottle end opposite the bottle tip being arranged radially inwards in relation to the axis of centrifugal rotation and comprising a sample outlet, a tube for connecting the bottle tip with a sample inlet and a cavity with an outer circumference that changes over the cross-section of the centrifuge bottle from bottle tip to bottle end. In a preferred embodiment, the radius of the sample outlet is higher than the radius of the sample inlet.

The centrifuge bottle is suitable for counterflow operations in centrifuges. The bottle is therefore suitable for rotation around a central axis and the shape of the cavity defined by the three angles enables to keep the forces acting on the sample in equilibrium. When separating cells or particles from a sample, it is important to note that smaller particles/cells sink more slowly than larger ones and in order to optimise the volume of the centrifuge bottle, the shape of the cavity should be adapted accordingly, which is made possible the centrifuge bottle according to the present invention.

The outer circumference of the cavity is determined by at least three angles α, β and γ extending from a centre axis of the centrifuge bottle and at least one bottle end area subsequent to γ. The angle β defines a tip section of the centrifuge bottle extending from the bottle tip to an intermediate section. The cross section of the tip section has to be selected in a way that the fluid velocity is significantly higher than the settling velocity. This is advantageous to prevent pelleting of particles/cells. The angle α defines the intermediate section extending between the tip section and a rear section and the angle γ defines the rear section extending between the intermediate section and the bottle end area. The cross section of the intermediate section can be selected based on the particle/cell density, the fluid density and its viscosity of the individual sample to be handled. Preferably, a desired speed of centrifuge and flow rate of the sample is maximised where an equilibrium between centrifugal force induced settling velocity and flow velocity is given. The intermediate section is the part of the cavity where an equilibrium can be achieved. It is important for the correct calculation that the value of γ is greater than the value of a. The rear section serves as a barrier-section for sample particles. It is designed in a way that the settling velocity is higher than the fluid velocity. This prevents particles from leaving the bottle, which could lead to in incorrect sample analysis. The angle γ is preferably in a range to maintain a factor of at least 2 from settling velocity over flow velocity of the sample. This is advantageous to increase the separation efficiency.

The inlet and outlet parts of the centrifuge bottle are preferably kept thin compared to the remaining sections to avoid sedimentation of sample particles. Another advantage of the present invention is the improvement of the centrifuge bottle's separation performance and the prevention of pelleting. The centrifuge bottle is built for improved separation by its rear section that is provided as a barrier-section.

In a preferred embodiment, the tip is a rounded tip. A rounded tip allows the flow of the sample from the tube to be directed advantageously into the centrifuge bottle. The angles may be adjusted depending on the nature of the sample to be centrifuged. They can be calculated to fit for a certain particle density, fluid density or mass flow of the centrifuge process in order to gain improved results.

The shape of the centrifuge bottle's cavity allows the counterflow of the sample to reverse its direction if it is fed into the bottle by use of the tube.

According to an embodiment of the invention the value of β is smaller than that of α. For example, β may between about 0° to about 45°. A preferred range is between 4° to 16°, particularly preferred between 4° to 8°. The larger angle α results in the larger volume towards the centre of the bottle and a smaller angle β towards the tip leads to increased sample fluid velocity and a uniform inflow. The combination helps to improve the overall separation performance of the centrifuge bottle. For the concentration of a certain particle/cell size of a sample, the bottle size and shape can be customised for the desired effect by adapting one or more of the angles α, β and γ.

According to a further embodiment of the invention the value of β may be positive or negative or 0°. The value of β can be customised so that the bottle can be designed for specific sample properties. For example, the particle density, fluid density, mass flow and particle size of samples to be separated can be included in the calculation of a preferred angle β.

According to a further embodiment, the intermediate section is longer than the tip section and is longer than the rear section. The volume of the intermediate section should be the largest compared to the other sections in order to be able to set the equilibrium of the forces in this section for improved particle/cell concentration.

According to a further embodiment the bottle end area comprises a constant circumference. Preferably, the radius of the bottle end area corresponds to the largest extension of the preceding rear section. In this way the conditions of the rear section are maintained longer. This is advantageous for the sample flow and also facilitates the production of the centrifuge bottle. This part can be held short compared to other sections of the bottle, especially compared to the intermediate section.

According to a further embodiment the bottle end area comprises a first area with constant circumference and a second area with constant circumference. The diameters of the first and second area can differ in size to create a graded bottle end area. The diameters of the areas can be selected to suit the samples to be analysed and their composition, for example in terms of density and/or particle structure. This way, the accuracy of the analysis can be further improved in an advantageous manner.

According to a further embodiment the diameter of the first area with constant circumference is greater than the diameter of the second area with constant circumference. This reduces weight and volume of the centrifuge bottle and therefore also costs for manufacturing. A decreased volume due to a smaller bottle end area also decreases the applied forces on the centrifuge bottle by centrifugal force during counterflow operation which has a positive effect to avoid damage to the centrifuge bottle that could render the sample unusable and ensures proper function of the centrifuge bottle.

However, it would also be possible to provide an area with a decreasing circumference following the section defined by γ instead of an area with constant circumference.

According to a further embodiment the tube is a central tube extending inside the cavity. Depending on the selected use for certain sample types, this type of tube guidance in the centre of the cavity may be the most suitable for achieving improved results.

According to a further embodiment the bottle tip is a double rounded tip comprising a radially inwards orientated spike for eccentric diversion of the sample flow. The bottle tip can be designed as a B-shaped tip, for example, to ensure a uniform, bisected sample flow out of the tube extending inside the cavity and from the tip into the cavity of the centrifuge bottle. The combination of the central tube extending inside the cavity with the double rounded tip comprising a radially inwards orientated spike can improve the sample flow, as the sample flowing through the tube centrally arranged in the cavity of the centrifuge bottle then can be diverted into the cavity in equal parts, whereby it can be inserted in a more precisely targeted manner.

According to a further embodiment the tube is arranged outside of the cavity. The tube can, for example, extend along the outer surface of the centrifuge bottle. This arrangement can be advantageous to safe space inside the cavity of the centrifuge bottle.

### EXAMPLE

In an exemplary embodiment of the invention, a centrifuge bottle for counterflow operation is provided with the following dimensions:

| Tip radius | 0.015 | m |
|---|---|---|
| Tip distance a | 0.0006 | m |
| Angle β | 67.00° | |
| Angle α | 4.50° | |
| Angle γ | 25.00° | |
| Distance from centre to tip | 0.20 | m |
| Length of angle α | 0.085 | m |
| Length of γ | 0.055 | m |
| Length of constant area | 0.015 | m |
| Radius of first constant area | 0.050 | m |
| Radius of second constant area | 0.020 | m |

This centrifuge bottle shape is designed for an optimised use under the following conditions:

| | | |
|---|---|---|
| Input Revolution | 3000 | U/min |
| Volume flow V | 0.000 | m³/s |
| Tube diameter D | 0.006 | m |
| Kinematic viscosity | 1.01E−06 | m²/s |
| Density_{Liquid} | 1000 | kg/m³ |
| Density_{Particles} | 1100 | kg/m³ |
| Particle diameter | 1.00E−05 | m |

This example can be modified depending on the type of sample to be centrifuged. The more adapted the centrifuge bottle is to a specific sample type and the ambient parameters, the more precisely the sample can be fractionated.

Further features, details and advantages of the invention are apparent from the wording of the claims and from the embodiment described below with reference to the drawings.

The accompanying drawings, which are incorporated in and constitute part of this specification, illustrate embodiments of the invention and, together with the general description given above and the detailed description of the embodiments given below, serve to explain the principles of the present invention.

In the drawings:

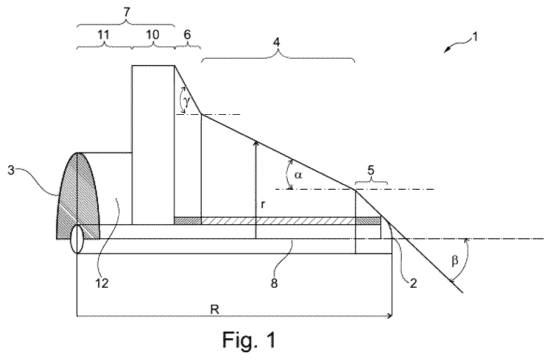

FIG. 1 is a side view of centrifuge bottle for counterflow operation according to an embodiment of the invention;

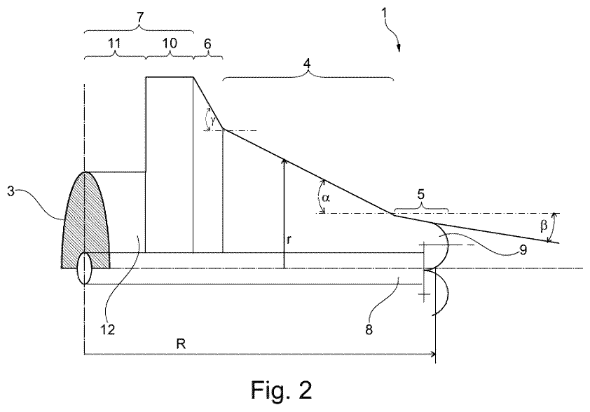

FIG. 2 is a side view of a centrifuge bottle for counterflow operation with a double rounded tip; and

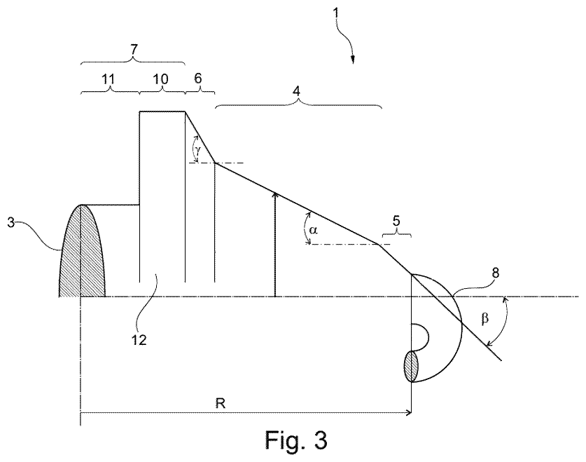

FIG. 3 is a side view of a centrifuge bottle for counterflow operation with an outer inlet.

FIG. 1 shows a centrifuge bottle 1 according to an embodiment of the present invention. The centrifuge bottle 1 comprises a bottle tip 2 and a bottle end 3 on its opposite side. Starting from bottle tip 2, a tip section 5, an intermediate section 4, a rear section 6 and then a bottle end area 7 extend between bottle tip 2 and bottle end 3. In this embodiment example, the bottle end area 7 is divided into a first area with constant circumference 10 and a second area with constant circumference 11. It would also be possible to provide the bottle end area 7 with only one constant circumference. In addition, it would also be possible to provide a bottle end area 7 divided into an area with a constant circumference and an area whose circumference decreases towards the bottle end 3. The precise design can be adapted to the individual properties of different samples so that a high level of measurement accuracy can always be achieved.

The outer dimensions of the tip section 5 are defined by an angle β, the intermediate section 4 by an angle α and the rear section by an angle γ, each measured from the centre axis A. The angle γ is significantly steeper than α and β. The circumference of each section 4,5 and 6 increases towards the direction of the bottle end 3.

The centrifuge bottle 1 can be used in a centrifuge to separate samples into different components, for example to separate cells of a sample based on their size and density, which have an influence on their sedimentation behaviour. Cells with fewer density and/or smaller diameter can be separated and eluted from the sample. That ensures proper separation of sample fragments for further analysis and may for example be used for the separation of blood cells. Three different angles α, β, γ define the of the outer circumference of the bottle from tip to bottle end area.

The bottle tip 2 is preferably a rounded tip as shown in this embodiment. The angle β of tip section 5 of the centrifuge bottle's 1 part that follows the bottle tip 2 is steeper than that defining the bottle tip 2. This serves to reverse the flow of the sample inside the centrifuge bottle 1. The angle α of the intermediate section 4 is chosen in a way to guarantee an equilibrium of flow velocity and settling velocity. This intermediate section 4 defines the part of the centrifuge bottle 1 where a fluidised bed is achieved, which is crucial for the proper separation of particles of the sample to be analysed. Following the intermediate section 4, the rear section 6 is shown. The angle γ which determines the course of the outer circumference of the rear section 6 from intermediate section 4 towards the bottle end area 7, is much steeper than α. This creates a barrier for the particles of the sample to be analysed. The angle γ should be in a range to maintain a factor of at least two from settling velocity over flow velocity. The bottle end area can be separated into different areas. As shown in this exemplary embodiment, it is possible to provide a first area that has a constant circumference 11. The dimensions of this sections can be defined by the method of production of the centrifuge bottle 1. The diameter over the entire first area 10 corresponds to the largest extension of the rear section 6. In this embodiment the bottle end area 7 comprises a second area with constant circumference 11 following the first area 10. The constant circumference of the second area 11 has a significantly smaller diameter than the first area 10 in order to reduce weight and volume and therefore minimise the load that is applied to the centrifuge bottle 1 and to reduce costs for production. However, it is also possible to design the bottle end area 7 differently, for example only as a one-piece area with a constant circumference or also as a one-piece area with a decreasing or increasing circumference, depending on the desired design and the substances to be analysed or with a first area with constant circumference 10 and a second area with constant circumference 11 that do not differ greatly from each other, but where the circumference of the second area 11 is only slightly smaller than that of the first area 10. The embodiment shown in FIG. 1 uses the space for particle concentration inside the cavity 12, so that good separation can be achieved by rear section 6 that acts as barrier-section.

The tip 2, which is a rounded tip in this embodiment, is advantageous to prevent pelleting of particles/cells of the sample to be centrifuged. The shape of the centrifuge bottle 1 allows to achieve a high particle/cell concentration in the intermediate section 4 and a highly efficient separation in the rear section 6. Overall, the centrifuge bottle 1 provides an improved separation performance when used with counterflow operation.

FIGS. 2 and 3 show embodiments of centrifuge bottles 1 with different bottle tip 2 variants. Apart from the bottle tip 2 variants, the centrifuge bottles 1 shown in FIGS. 2 and 3 correspond in their design, in particular the outer shape, to the centrifuge bottle 1 in FIG. 1.

FIG. 2 shows a centrifuge bottle 1 with a double rounded tip 9. The double rounded tip 9 is in a B-shape at the front, which ensures a continuous flow in two separate halves after leaving the tube 8 through its double rounded tip 9 due to the radially inwards orientated spike. The tube 8 is a central tube extending inside the cavity along the centre axis. This way, the flow is not interrupted but still evenly separated and distributed into the cavity 12, which can be advantageous for certain sample types. FIG. 3 shows an embodiment of the centrifuge bottle 1 for counterflow operation with an adapted bottle tip 2, which is connected to a tube that is arranged outside of the cavity 12 of the centrifuge bottle 1. This can be used to supply the sample to the centrifuge bottle 1 while at the same time space is saved inside the centrifuge bottle 1. The different types of tips and/or tubes can be selected depending on the sample type to be treated, so that performance is always optimised.

### REFERENCE SIGNS

1 Centrifuge bottle
2 bottle tip
3 bottle end
4 intermediate section
5 tip section
6 rear section
7 bottle end area
8 tube
9 double rounded tip
10 first area with constant circumference
11 second area with constant circumference
12 cavity
α angle α
β angle β
γ angle γ

1. A centrifuge bottle (1) for counterflow operation, comprising:
a bottle tip (2) being arranged radially outwards in relation to an axis of centrifugal rotation;
a bottle end (3) opposite the bottle tip (2) being arranged radially inwards in relation to the axis of centrifugal rotation and comprising a sample outlet;
a tube (8) for connecting the bottle tip (2) with a sample inlet;
a cavity (12) with an outer circumference that changes over the cross-section of the centrifuge bottle (1) from bottle tip (2) to bottle end (3);
wherein the outer circumference of the cavity (12) is determined by at least three angles α, β and γ extending from a centre axis of the centrifuge bottle (1) and at least one bottle end area (7) subsequent to γ,
wherein β defines a tip section (5) of the centrifuge bottle (1) extending from the bottle tip (2) to an intermediate section (4),
wherein α defines the intermediate section (4) extending between the tip section (5) and a rear section (6),
wherein γ defines the rear section (6) extending between the intermediate section (4) and the bottle end area (7),
characterised in that the value of γ is greater than the value of α.

2. The centrifuge bottle (1) according to claim 1, characterised in that the value of β is smaller than that of α.

3. The centrifuge bottle (1) according to claim 1, characterised in that the value of β may be positive or negative or 0°.

4. The centrifuge bottle (1) according to claim 1, characterised in that the intermediate section (4) is longer than the tip section (5) and is longer than the rear section (6).

5. The centrifuge bottle (1) according to claim 1, characterised in that the bottle end area (7) comprises a constant circumference.

6. The centrifuge bottle (1) according to claim 1, characterised in that the bottle end area (7) comprises a first area with a constant circumference (10) and a second area with a constant circumference (11).

7. The centrifuge bottle (1) according to claim 6, characterised in that the diameter of the first area with constant circumference (10) is greater than the diameter of the second area with constant circumference (11).

8. The centrifuge bottle (1) according to claim 1, characterised in that the tube (8) is a central tube extending inside the cavity (12).

9. The centrifuge bottle (1) according to claim 8, characterised in that the bottle tip (2) is a double rounded tip (9) comprising a radially inwards orientated spike for eccentric diversion of the sample flow.

10. The centrifuge bottle (1) according to claim 1, characterised in that the tube (8) is arranged outside of the cavity (12).
